(19) United States
(12) Patent Application Publication
(10) Pub. No.: US 2005/0219031 A1
(43) Pub. Date: Oct. 6, 2005

(54) Method for RIAA correction of audio signal with use of transformer

(75) Inventor: Alexander Y. Sokolov, Moscow (RU)

Correspondence Address: JOSHUA D. ISENBERG, 204 CASTRO LANE, FREMONT, CA, 94539, US

(73) Assignee: Outsource Technologies, Inc., San Rafael, CA (US)

(21) Appl. No.: 10/897,574

(22) Filed: Jul. 22, 2004

(30) Foreign Application Priority Data
Apr. 1, 2004 (RU) 2004109701

(51) Int. Cl. H02M 3/335

(52) U.S. Cl. 336/212

(57) ABSTRACT

RIAA correction of audio frequency signals is described. A RIAA-correcting pre-amplifier uses a transformer having a primary winding and two or more secondary windings, with two of the secondary windings playing essential role in RIAA-correction. A magnetic core of the transformer includes two or more separated parallel magnetic circuits.

### CROSS REFERENCE TO RELATED APPLICATION

This application claims priority from Russian Patent Application 2004109701, to Alexander Sokolov, filed Apr. 1, 2004, the disclosures of which are incorporated herein by reference.

This application is related to commonly assigned co-pending U.S. patent application Ser. No. ______ (Attorney Docket No.: OST-001) to Alexander Sokolov entitled “METHOD FOR RIAA CORRECTION WITHOUT CAPACITORS IN CORRECTING CIRCUITS”, which is filed concurrently herewith. This application is also related to commonly assigned co-pending U.S. patent application Ser. No. ______ (Attorney Docket No.: OST-003) to Alexander Sokolov entitled “METHOD FOR RIAA CORRECTION OF AUDIO SIGNAL WITH USE OF TRANSFORMER AND CAPACITOR”, which is filed concurrently herewith.

### 1. FIELD OF THE INVENTION

The invention relates to electronic equipment, hi-fi audio systems. It can be used in electronic pre-amplifiers for phono players (RIAA-correctors).

### 2. BACKGROUND

Audio signal recording on a phono disk is based on the well-known Recording Industry Association of America (RIAA) correction procedure. According to this procedure the amplitude of an electrical signal recorded on disk depends on the frequency. Such correction is carried out to improve the dynamic range of the signal. When the disk is played back, the electrical signal coming from the pickup cartridge to the output power amplifier and later to the speaker has to pass through a pre-amplifier with additional frequency correction, in which the reverse correction procedure is applied.

Mathematically expressed the frequency correction transmission function from the input to output of the pre-amplifier has the form:
Uout/Uin=K0*(1+i*w*b)/((1+i*w*b1)*(1+i*w*b2)),

where Uout and Uin are signal amplitudes at the output and input, respectively,

Ko is frequency independent amplification factor,
w=2*π*f,

f is the signal frequency,

b=318, b1=75, b2=3180 are time constants, expressed in milliseconds,

i is complex unity.

There are many different realizations of RIAA-correctors. Among them one can find transistor, solid state and vacuum tubes circuits.

Usually capacitors are implemented in such pre-amplifiers as the elements featuring frequency-dependent characteristics.

In spite of their simplicity of use, capacitors introduce the disturbances into the signal transmitted. This circumstance, however, degrades the audio characteristics of the pre-amplifier. The electrical parameters of capacitors depend essentially on the dielectrics used, the foil and the winding method. As a result capacitors possess such undesirable features as non-linearity, inductance, energetic losses during the electrical signal transmission, etc. Experts often notice the dependence of the sound on the capacitors types, the coarse sounding of cheap capacitors in the upper register of the sound signal, sticky and dim sound.

One of the ways to perform RIAA-correction is to use the transformer with two secondary windings, shown in FIG. 1. The transformer has a primary winding I and two secondary windings II-1 and II-2, which are loaded on two resistors. The electrical circuit pointed out provides the necessary form of amplitude vs. frequency curve of RIAA correction.

FIGS. 2a-2b show the transformer given in FIG. 1 in more detail. The core of the transformer has a complicated form, which is expressed in different length of steel plates 1 and 3 in comparison with a central plate 2. Due to this difference in length there exists, after assembling the core, an additional air gap x between the central plate 2 and a lower plate 4 (FIG. 2a).

The primary winding I is placed on the side plates 1 of the core, while the secondary winding II-2 is winded over the primary, and the secondary winding II-1 is wound on a separate coil, placed on the central plate 3 of the core. The position of the windings is illustrated in FIG. 2b.

The primary winding is connected to a vacuum tube base amplifying cascade, such that in the absence of a signal at the input a constant non-zero current is present in the primary winding.

The principle RIAA correction in the circuit in FIG. 1 is based upon two leakage inductances of secondary windings with respect to the primary one. The first leakage inductance of the secondary winding II-2 has a small value and is due to parasitic leakage inductance of the winding. This leakage inductance is a feature of every transformer and is well described elsewhere. Parasitic leakage inductances are usually small and depend on the number of turns in the winding and the geometry of in the winding, and also on the sectioning of the windings. By changing these parameters one can obtain the necessary value of leakage inductance.

The artificial leakage inductance of winding II-1 has large value, and is achieved in the transformer due to the splitting of original magnetic flux generated by the primary winding (which passes on plates 1 of the core) into two directions: one along plates 2 with air gap x, and another along plate 3 (see FIG. 2).

In result, some part of the magnetic flux of primary winding I doesn't reach the winding II-1, and is closed on the plates 2 of the core.

Such construction provides high value of the leakage inductance of the core, which is difficult to achieve by other means.

Due to the leakage inductances the high frequency part of electrical signal, transmitted from the primary winding to each of the secondary windings and resistors, is reduced, therefore the transformation factor of the signal from the primary winding to each of the resistors depends on the frequency. The ratio of smaller leakage inductance of winding II-2 to the loading resistor is given and must be equal to a correction time constant b1 (75 microseconds), while the ratio of higher value of leakage inductance of winding II-1 to the loading resistor must be equal to a correction time constant b2 (3180 microseconds). After the summation of the signals from two resistors, taking into account the different transformation factors from the primary to each of the secondary windings, the signal amplitude at the output of the corrector has right frequency corrected value.

The disadvantage of this construction of the transformer is that the non-uniform magnetization appears in the different parts of the core due to the constant magnetizing current in the primary coil, which is the feature of single-ended topology of vacuum tube amplifying stage. According to Kirchoff's law for magnetic circuits the magnetic flux of constant magnetization at the part 1 of the core is equal to the sum of fluxes at parts 2 and 3 (FIG. 2a). Because the width of the core plates at part 1 is essentially smaller than the sum of width of plates at 2 and 3, due to the equality of the magnetic flux sum the magnetic induction of constant magnetization is higher at part 1 than at parts 2 and 3.

FIG. 3 shows the typical magnetization curve for ferromagnetic substance. As it is seen from the figure, the most linear part of the dependence of magnetic induction on magnetic field intensity is achieved only in small interval of intensity values (part c-d of the curve in FIG. 3). At the initial part of the curve near zero strong non-linearity is observed, as well as at high values of the field intensity, where the material of the core experiences the magnetic saturation.

The non-uniformity of the core magnetization applies the certain restriction on the original inductance of the primary winding. This inductance has a maximum value only on the linear part of the core magnetization curve. This inductance has to have a sufficiently high value necessary for the transmission of a low-frequency part of a signal by the transformer. This is usually achieved in transformers with the choice of initial magnetization at the linear interval. Moreover, the enhanced non-linearity of magnetic parameters of the core material is the source of the enhanced non-linearity of the leakage inductance, and consequently, non-linear signal distortions.

The enhanced non-linearity of the magnetic core material parameters simultaneously is the source of dependence of the leakage inductance on the primary winding magnetizing current of the vacuum tube amplifier. The tubes exhibit the changes of parameters after a long time of usage. This usually leads to the fact that the anode current of the tube flowing through the primary winding can slightly change. This might cause instability of the required value of the inductance and therefore even violation of RIAA-correction.

Another disadvantage of the described above construction of the transformer is the additional air gap x in FIG. 2a, which demands the use of non-standard form of magnetic plates. There is a need in the art for RIAA-correction that uses an industrial transformer core of a common form for the purpose of the core of a RIAA transformer.

### 3. BRIEF DESCRIPTION OF THE DRAWINGS

FIG. 1 shows a circuit with transformer and two secondary windings used for RIAA-correction according to the prior art.

FIGS. 2a-2b show the construction of a transformer of the type depicted in FIG. 1.

FIG. 3 shows a typical magnetization curve of a transformer core.

FIG. 4 illustrates the construction of the transformer according to a first embodiment of the present invention.

FIG. 5 illustrates the construction of the transformer according to a second embodiment of the present invention.

FIG. 6 illustrates the construction of the transformer in the cross-section along the winding plane according to a third embodiment of the present invention.

FIG. 7 illustrates the construction of the transformer in the cross-section along the winding plane according to a fourth embodiment of the present invention.

FIG. 8 illustrates the construction of the core and the position of the windings according to a fifth embodiment of the present invention.

FIG. 9 illustrates one of possible constructions of the core according to a sixth embodiment of the present invention.

FIG. 10 illustrates on of possible devices according to embodiments of the present invention.

FIG. 11 illustrates a transformer made of two parallel cores having equal cross-section areas according to alternative embodiments of the present invention.

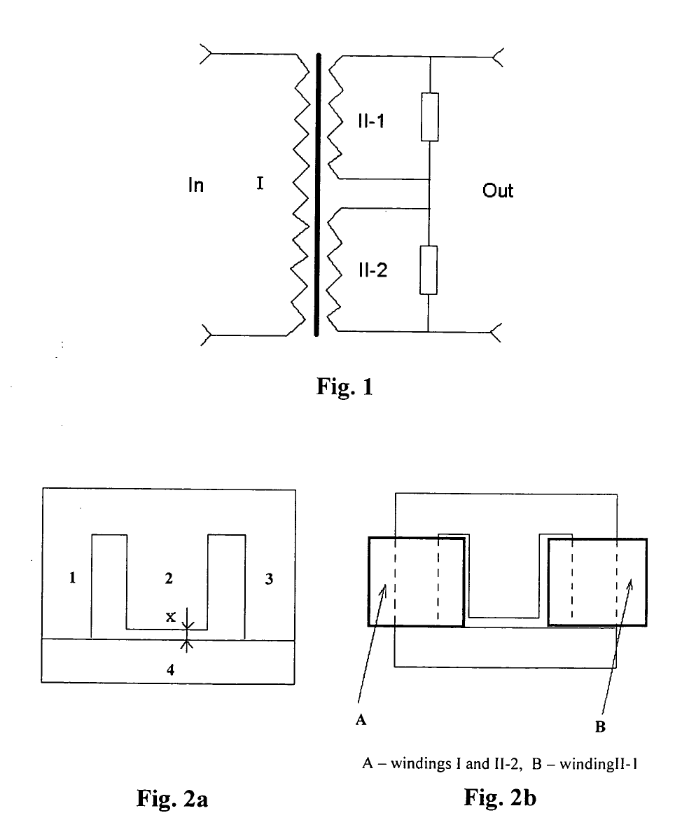

### 4. DETAILED DESCRIPTION

According to a first embodiment, a method of RIAA correction of audio frequency signal uses a transformer having a primary winding and two or more secondary windings, with two of the secondary windings playing an essential role in RIAA-correction. The transformer uses a magnetic core having two or more separated parallel magnetic circuits.

A first technical result that can be achieved in this embodiment is that the construction of the transformer can be simplified. The core can be made of several independent cores.

A second technical result that can be achieved in this embodiment is also that the value of the leakage inductance can be conveniently varied via the variation of magnetic resistance of the separate cores. For example, if these cores are made from the set of plane magnetic plates, the magnetic resistance of the core can be changed by the variation of the required number of plates in the cores forming the given magnetic circuits.

A third technical result that can be achieved in this embodiment is also that the value of the leakage inductance can be conveniently varied via the variation of the distribution of the number of turns in the secondary windings without changing its transformation factor, if the winding is separated into several sections, each section placed on its own separate core.

A fourth technical result can be achieved in this embodiment is that a sixth embodiment (described below) can also be achieved in the case when all the separate parallel magnetic circuits of the core are embraced by the winding with the constant magnetizing current in the winding, and have equal magnetic resistances.

The construction of the transformer according to the first embodiment is illustrated in FIG. 4.

The transformer shown in FIG. 4 consists of a magnetic core made from two separate magnetic pole pieces 101 and 102, which have the magnetic resistances Rm1 and Rm2, respectively. A primary winding I is wound simultaneously on the two magnetic pole pieces 101, 102, and a secondary winding II is divided into two sections with number of turns n1 and n2 in each. Each section is placed on a separate one of the magnetic pole pieces 101, 102.

FIG. 4 shows only the one of the secondary windings taking part in RIAA-correction of the signal. Another secondary winding can be done in the similar way, or in some other way. For a example, this winding can be wound upon the primary winding I similar to the prototype of the invention, and have some small parasite leakage inductance, which will be used in the determination of the smallest time constant b1 (75 microseconds).

According to Ohms law for magnetic circuits magnetic fluxes Φ1 and Φ2 in each of magnetic pole pieces 101 and 102 are equal to
Φ1=(N1*I1+n1*I2)/Rm1,
Φ2=(N2*I2+n2*I2)/Rm2,

where I1 and I2 are the currents in the primary and secondary windings, respectively, N1 is the number of turns in the primary winding. (The direction of the currents is selected such that their magnetic fluxes add up.) The sum of n1 and n2 is equal to the total number of the turns in the secondary windings:
N2=n1+n2.
Magnetic flux F1, which passes through N1 turns of the primary winding, and which temporal variations determine the value of electromotive force (EMF) in the primary winding, is equal to
F1=N1*(Φ1+Φ2).
The total magnetic flux F2, which pass through n1 and n2 turns of the secondary winding, which temporal variations determine the value of EMF in the secondary winding, is equal to
F2=n1*Φ1+n2*Φ2.
Expressing F2 through F1 yields
F2=K*F1+Ls*I2,
where K is the transformation factor from the primary to the secondary winding:
K=(n1*Rm2+n2*Rm1)/(N1*Rm1+N1*Rm2),
and Ls is the leakage inductance, calculated with respect to the secondary winding:
Ls=(n1−n2)*(n1−n2)/(Rm1+Rm2).
In particular case when separate magnetic circuits have equal magnetic resistances, Rm1=Rm2=Rm, one obtains:
K=N2/(2*N1),
Ls=(n1−n2)*(n1−n2)/(Rm1+Rm2).
By varying the number of turns n1, n2 in the two sections of secondary winding under a constant value of the transformation factor K (thus the constant sum of n1 and n2), or varying the magnetic resistance of the magnetic pole pieces 101 and 102, one can obtain the necessary value of the leakage inductance Ls. It seems that the most convenient way is to vary the number of turns in each section keeping the sum of n1 and n2 constant without changing the magnetic pole pieces 101, 102.

According to a second embodiment of the invention an alternative method of RIAA correction of audio signal uses a transformer is a variation on the first embodiment having a core in the form of a standard shield detachable band core (sometimes referred to as a magnetic yoke) with a primary winding placed on a center part of the core and at least one of the secondary windings, used in RIAA-correction, consisting of two sections (parts), each section being placed on its own side of the core, in one particular case the number of turns in one section is equal to zero, in this case all secondary windings are wound in one section on one side of the core.

A first technical that can be result achieved due to the second embodiment is that a standard industrial core of shield type made from magnetic band (e.g., a magnetic yoke) can be used.

A second technical result that can be achieved due to the second embodiment is also that a sixth embodiment (described below) if the cross-section area of the magnetic band from which the core is done is constant along its length and equal in two halves of the core, the air gap is same in both halves, and the magnetizing current flows in primary coil.

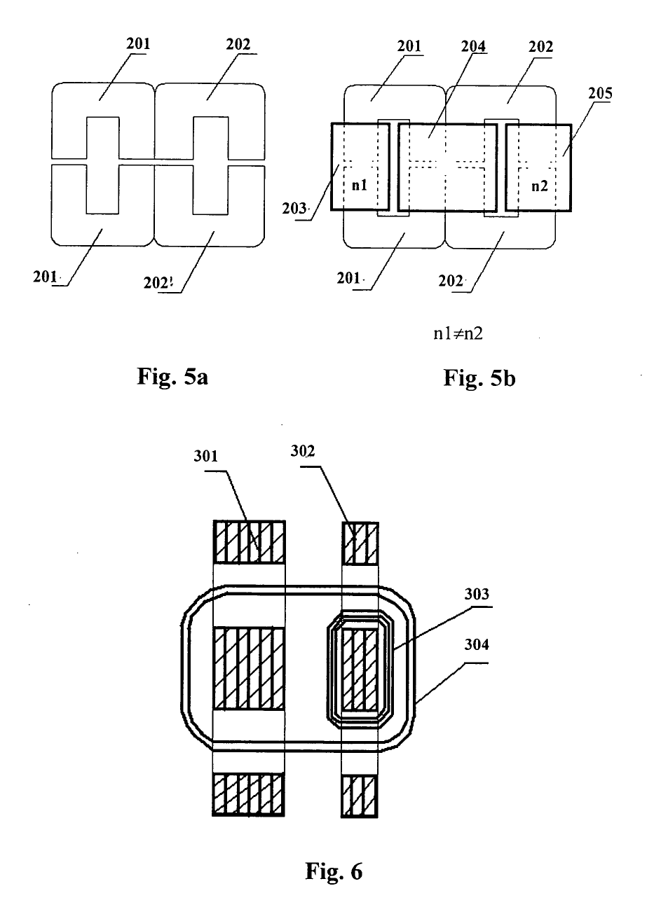

The construction of the transformer according to the second embodiment is illustrated in FIGS. 5a-5b.

The core of the transformer is shown in FIG. 5a, and the position of the windings is shown in FIG. 5b. The core consists of two magnetic pole pieces 201 and 202, each made from two equal halves. The primary winding 204 is placed on the central part of the core, and the secondary winding is divided into two section 203 and 205 having n1 and n2 number of turns, respectively, each section is placed on its side of the core.

According to a third embodiment of the invention an alternative method of RIAA correction of audio signal with the use of the transformer based on the first embodiment uses a transformer core of the shield type, made from the set of flat magnetic plates and separated into two or more parts, each of the part is made from the set of given number of plain magnetic plates, the parts of the core are placed at some distance from each other, and at least one of the windings which takes part in the RIAA-correction of the signal is wound over a central part of only one core, and the primary winding is wound over the central part of all parts of the magnetic core and embraces simultaneously all parts of the core.

A first technical result that can be achieved due to the third embodiment is that standard industrial core of shield type made from the set of plain magnetic plates can be used.

A second technical result that can be achieved due to the third embodiment is also that a sixth embodiment (described below) if the width of the plates is double in the center part of the core, the air gap is equal for all parts of the core and all parts of the core have equal width of the plates set, and the magnetizing current flows in primary coil.

The construction of the transformer according to the third embodiment is illustrated in FIG. 6. The magnetic core consist of two parts 301 and 302, placed at some distance from each other, each part of the core is made from the set of flat magnetic plates. The transformer has two windings a secondary 303 and a primary winding 304. The secondary winding 303 embraces only one part of the core, and the primary winding 304 embraces simultaneously both parts.

According to a fourth embodiment of the invention an alternative method of RIAA correction of audio signal uses of a transformer with a core of the detachable band shielded-type, having two or more detachable band shielded-type pole pieces, which are placed at some distance from each other. At least one of the windings which takes part in the RIAA-correction of the signal is wound over a central part of only one core, and the primary winding is wound over the central part of all parts of magnetic core and embraces simultaneously all parts of the core.

A first technical result that can be achieved due to the fourth embodiment is that standard industrial detachable band shielded-type core can be used.

A second technical result achieved that can be due to the fourth embodiment is also that a sixth embodiment (described below) if the cross-section area of the magnetic band from which the cores are made doesn't change along the band length, the cross section areas and air gaps are equal for all parts of the core, and the magnetizing current flows in primary coil.

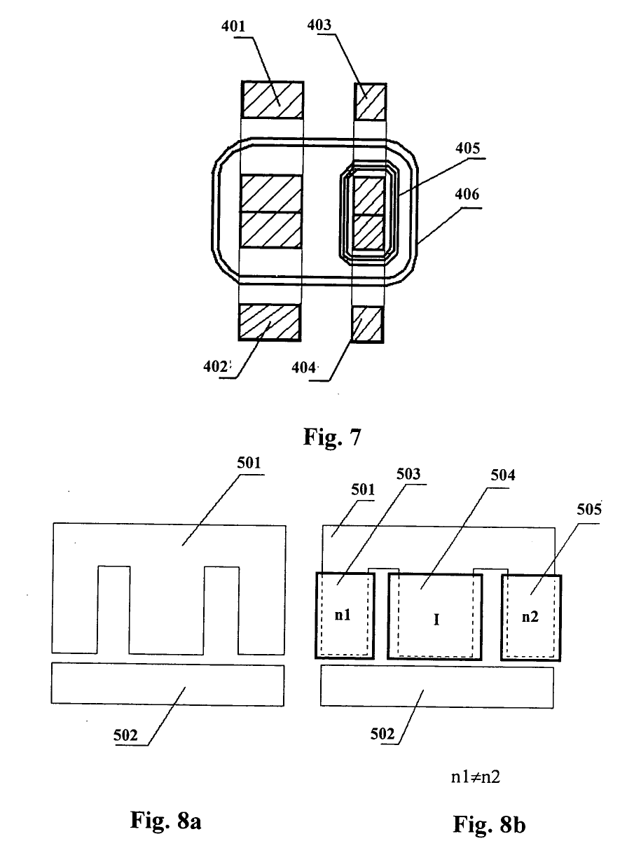

The construction of the transformer according to the fourth embodiment is illustrated in FIG. 7. The magnetic core consists of two core parts which may each be made in two sections respectively indicated 401, 402 and 403, 404 placed at some distance from each other, each section of the core is made from magnetic band. The transformer has two windings, a primary winding 406 that embraces simultaneously all the core parts, e.g., sections 401, 402, 403, 404, and the secondary winding embraces only one core part, e.g., sections 403, 404.

According to a fifth embodiment of the invention an alternative method of RIAA correction of audio signal may be implemented with the use of a transformer having a primary winding and two or more secondary windings, with two of the secondary windings playing essential role in RIAA-correction. The transformer having a shielded-type core made from magnetic plates, with the primary winding wound on a central part of the core and at least one of the secondary windings that takes part in RIAA correction having two sections (parts). Each of the sections is placed on the side part of the core, in one particular case the number of turns in one section is equal to zero. In this case all secondary windings are wound as a whole on one side part of the core.

A first technical result that can be achieved due the fifth embodiment is that standard industrial detachable shielded-type core made from plain magnetic plates can be used.

A second technical result achieved due to the fifth embodiment is also that a sixth embodiment (described below) can be realized, if the size of the plates in the central type is double of the size at other parts, the air gap after core assembling is same for all parts of the core, and the magnetizing current flows in primary coil.

The construction of the core and the position of the windings according to the fifth embodiment are illustrated in FIGS. 8a-8b. As shown in FIG. 8a, the core consists of upper and lower magnetic plates 501 and 502. The central part and the side parts are separated from the lower plate 502 by a gap. The upper plate 501 has a central part and side parts. As shown in FIG. 8b a primary winding 504 is located on the central part of the upper plate, while a secondary winding is divided into two sections 503 and 505 placed on the side parts of the upper plate.

For the pointed construction of the transformer one can obtain the expression for leakage inductance similar to expression (3).

According to the sixth embodiment of the invention an alternative method of RIAA correction of audio signal with the use of the transformer having primary and two or more secondary windings, with two of the secondary windings playing essential role in RIAA-correction, uses magnetic induction under the action of a constant magnetizing current in one of the windings having equal values at all parts of the core, neglecting by non-uniformity the induction in the cross section plane and losses of magnetic induction along the core, as well as the areas exhibit a bend, or has an air gap or constrictive holes.

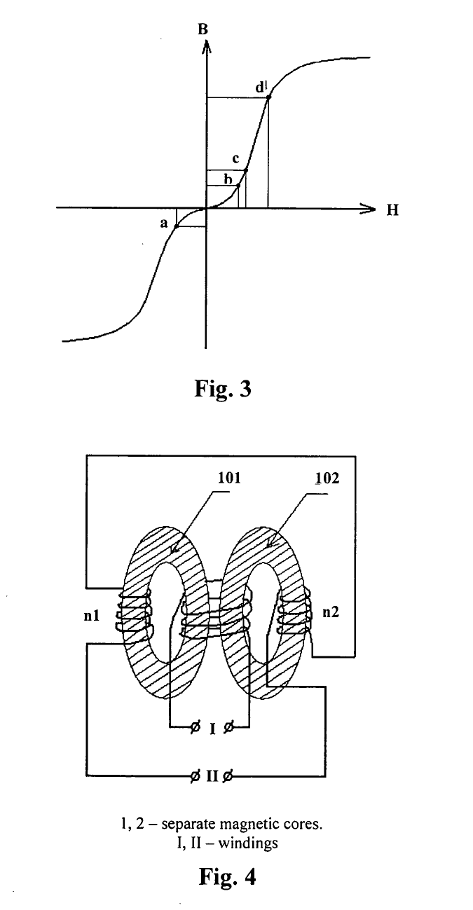

A first technical result that can be achieved by the sixth embodiment is expressed in the possibility to use equal values of core magnetization at its various parts corresponding to the most linear part of the material magnetization (e.g., the interval c-d in FIG. 3). This increases the magnetic permeability and inductance of the windings, reduces the non-linearity of dependence of leakage inductance on an AC signal, thus reducing non-linear distortions, and also reduces the variation of the leakage inductance due to instability of the magnetization current.

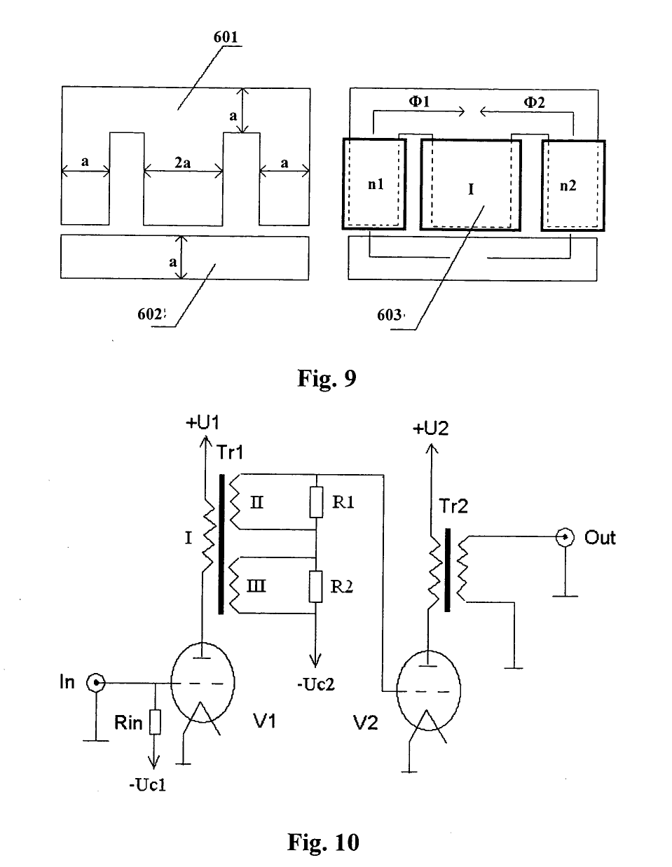

The one of possible constructions of the core according to the sixth embodiment is shown in FIG. 9. The core consists of the set of plain magnetic plates 601 and 602, having a double width in the central part, as well as an equal value of air gap in the central and side parts. If a primary winding 603 with constant magnetizing current is placed upon the central part of the core two equal magnetic fluxes Φ1 and Φ2 are generated in the side parts of the core, the sum of these two fluxes is equal to the magnetic flux at the part of the core, which is twice higher than each of the fluxes Φ1 and Φ2. Taking into account that the width of the central part of magnetic plates is twice of the width at other parts, all parts of the core are equally magnetized (with the exception of small areas where the core has a bend, or may have technological holes), and neglecting by small non-uniformity of the magnetic field in the cross-section plane of the core (this non-uniformity is due to small increase of magnetic field line length towards the outside edge of the core), and neglecting by inessential magnetic losses in the core along the core length. With appropriate selection of the number of turns and the magnetization current in the primary winding 603 the magnetic induction inside the core can be selected at the middle of the most linear part of magnetization curve.

According to a seventh embodiment, a method of RIAA correction of audio signal with the use of the transformer according to the first or fifth embodiments uses a RIAA-correcting pre-amplifier with a transformer that doesn't have any capacitors in other parts of the electrical circuit, with the possible exception of capacitors used in constant voltage power supplies.

A first technical result according to the seventh embodiment is expressed in that all distortions introduced by capacitors can be eliminated. Because the transformer is used in the correction circuit, the same transformer can be used simultaneously for signal transmission between amplification stages, and in this case one can eliminate capacitors completely.

### 5. REALIZATION

One possible device according to the first, second, sixth and seventh embodiments is shown in FIG. 10.

The device shown in FIG. 10 consists of a first electric vacuum tube e.g., a triode V1, having a grid that is connected to an input of the device and the input resistor Rin. The other lead of the input resistor Rin is connected to the source of constant negative grid voltage—Uc1, which is necessary for normal operation of the triode. The cathode of the triode V1 is connected to a point of zero potential (“ground”). The anode of the triode V1 is connected to a primary winding I of the transformer Tr1, the second end of the winding is connected to an anode voltage supply U1. Two secondary windings II and III of the transformer Tr1 are loaded on resistors R1 and R2. The resistors R1 and R2 are connected in series. Resistor R2's second lead is connected to a source of negative grid voltage −Uc2, which is necessary for normal operation of a second tube, e.g., a triode V2. Resistor R1's second lead is connected to a grid of the triode V2, the cathode of the triode V2 is connected to zero voltage point (“ground”), the plate of V2 is connected to the primary winding of a second transformer Tr2, the second end of the primary winding of the second transformer Tr2 is connected to a source of constant positive voltage U2. The secondary winding of the second transformer Tr2 is connected with one end to the output of the device, and with another end to the point of negative potential (“ground”). The second transformer Tr2 doesn't have any special features and provides the uniform transmission of electrical signal for all sound band frequencies.

The first transformer Tr1 may have the type of construction illustrated in FIGS. 5a-5b, i.e., in which every secondary winding II and III is wound only in one section and is placed upon one side of the core. For instance, if winding II is placed on the left side of the core and has a number of turns equal to n1, winding III is placed on the right side of the core and has number of turns n2. The core is made from two band cores having equal air gaps.

When an electrical signal is introduced into the input of the device this signal is initially amplified by the first triode V1 uniformly for all frequencies and passes them to the primary winding of the first transformer Tr1. For each of the secondary windings there is a leakage inductance:
Ls1=n1*n1/(2*Rm)
for secondary winding II, and
Ls2=n2*n2/(2*Rm)
for secondary winding III, where Rm is the magnetic resistance of the core parts.
Let N1 be the number of turns in the primary winding of the first transformer Tr1, and
Ls1/R1=t1=75 microseconds,
Ls2/R2=t2=3180 microseconds,
(n1*t2+n2*t1)/(n1+n2)=t=318 microseconds.
The last condition is approximately
n2/n1≈11.8.
If U1 is the AC sinusoidal voltage on the primary winding having the frequency w=2*π*f, neglecting by active resistances of the windings and energy losses in the core, and taking into account the given values of leakage inductances in the windings, one obtains the following expressions for signal voltages on R1 and R2:
U(R1)=U1*(n1/2*N1)*R1/(R1+i*w*L1)=U1*(n1/2*N1)/(1+i*w*t1),
U(R2)=U1*(n2/2*N1)*R2/(R2+i*w*L2)=U1*(n2/2*N2)/(1+i*w*t2).
The sum of voltages on two resistors which is applied on the input of the second triode V2, is equal to
U(R1)+U(R2)=U1*(n1+n2)/(2*N1)*(1+i*w*t)/((1+i*w*t1)*(1+i*w*t2)).
Thus, after amplification by the first triode V1 and signal correction on the first transformer Tr1, and resistors R1 and R2, the signal has the right frequency-corrected value. The second triode V2 performs the final amplification of the signal without any frequency correction, which through the second transformer Tr2 comes to the output of the device.

Besides, the value of magnetization current in the primary winding of Tr1, which is the same as plate current of the first triode V1, is selected such that all parts of the transformer core lay on the most linear interval of the magnetization curve of the core material.

A device based on the third, fourth, or fifth embodiments repeats the device considered above with the exception that the construction of the transformer Tr1 is carried out as described above with respect to the third, fourth, or fifth embodiments. In these cases each of the secondary windings is done as described above with respect to the third, fourth, or fifth embodiments.

For a device based on the fifth embodiment, the transformer may be made in a similar way with two secondary windings, each of them placed on the side part of a shielded-type core (magnetic yoke), made of a set of magnetic plates, the width of the plate is double at the center of the core.

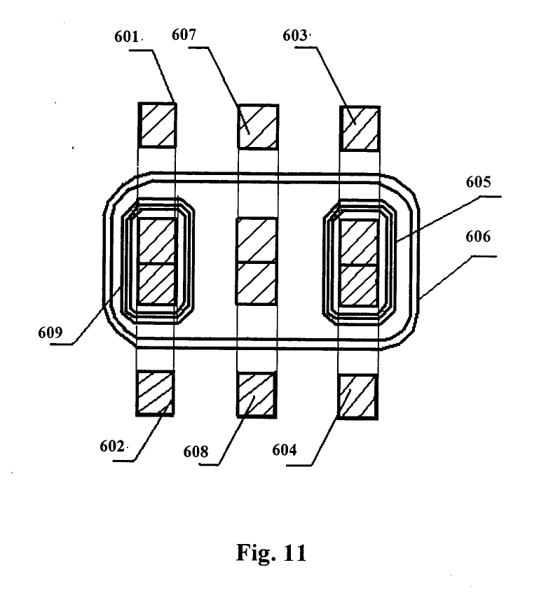

For a device according to the third or fourth embodiments the core of the transformer can be made of pairs of two parallel cores 601-602, 603-604 and 607-608, having equal cross-section areas, as shown in FIG. 11. The primary winding in this case is winding 606 (FIG. 11), and two secondary windings—windings 605 and 609. In the case the third embodiment, each of the core pairs 601-602, 603-604 and 607-608 may be made as a set of magnetic plates.

While the above is a complete description of the preferred embodiments of the present invention, it is possible to use various alternatives, modifications and equivalents. Therefore, the scope of the present invention should be determined not with reference to the above description but should, instead, be determined with reference to the appended claims, along with their full scope of equivalents. In the claims that follow, the indefinite article “A”, or “An” refers to a quantity of one or more of the item following the article, except where expressly stated otherwise. The appended claims are not to be interpreted as including means-plus-function or step-plus-function limitations, unless such a limitation is explicitly recited in a given claim using the phrase “means for” or “step for.”

1. A method of RIAA correction of audio frequency signals, comprising using in a RIAA-correcting pre-amplifier a transformer having a primary winding and two or more secondary windings, with two of the secondary windings playing essential role in RIAA-correction, wherein a magnetic core of the transformer includes two or more separated parallel magnetic circuits.

2. The method of claim 1, wherein the magnetic core of the transformer includes a shield detachable band core with the primary winding placed on the center part of the core and at least one of the secondary windings, used in RIAA-correction, consisting of two sections, each section being placed on its own side of the core.

3. The method of claim 2 wherein a number of turns in one section of the secondary winding is equal to zero, whereby the secondary winding is wound in one section on one side of the core.

4. The method of claim 3 wherein the core is made from two band cores having equal air gaps.

5. The method of claim 1, wherein the transformer includes a core of the shield type made from a set of flat magnetic plates and separated into two or more core parts, each core part being made from a set of a given number of flat magnetic plates, the cores being placed at some distance from each other, and wherein at least one of the windings taking part in the RIAA-correction of the signal is wound over a central part of only one core part, and the primary winding is wound over a central part of all magnetic core parts and embraces simultaneously all the separated core parts.

6. The method of claim 1, wherein the transformer includes a core of the standard detachable band shielded-type core, of the core having two or more detachable band shielded-type core parts, which are placed at some distance from each other, and at least one of the windings which takes part in the RIAA-correction of the signal is wound over a central part of only one core part, and the primary winding is wound over a central part of all magnetic core parts and embraces simultaneously all core parts.

7. A method of RIAA correction of audio signals comprising using in a RIAA-correcting pre-amplifier a transformer having a primary winding and two or more secondary windings, with two of the secondary windings playing essential role in RIAA-correction, wherein a core of the transformer is a shielded-type core made from magnetic plates, with the primary winding wound on a central part of the core, and at least one of the secondary windings which take part in RIAA correction being made in one or more sections, wherein each of the sections being placed on a side part of the core.

8. The method of claim 7, wherein the number of turns in one section of the secondary is equal to zero, whereby all secondary windings are wound as a whole on one side part of the core.

9. A method of RIAA correction of audio signal comprising using in a RIAA-correcting pre-amplifier a transformer having a primary winding and two or more secondary windings, with two of the secondary windings playing essential role in RIAA-correction, wherein a magnetic induction under the action of a constant magnetizing current in one of the windings has equal values at all parts of the core, neglecting non-uniformity of the induction in the cross section plane and losses of magnetic induction along the core, as well as the areas where the core exhibits a bend, has an air gap or constrictive holes.

10. A method of RIAA correction of audio signals according to claims 1 or 7, wherein the RIAA-correcting pre-amplifier doesn't have any capacitors in other parts of the electrical circuit, with the possible exception of capacitors used in constant voltage power supplies.

11. A circuit for a RIAA-correcting pre-amplifier, comprising:
a transformer having a primary winding and two or more secondary windings, with two of the secondary windings playing essential role in RIAA-correction, wherein a magnetic core of the transformer includes several separated parallel magnetic circuits.

12. The circuit of claim 11, further comprising a further comprising a vacuum triode having an anode that is electrically connected to the primary winding.

13. The circuit of claim 12, further comprising a second vacuum triode having a grid that is electrically connected to one of the secondary windings.
